(19) United States
(12) Patent Application Publication
(10) Pub. No.: US 2020/0212591 A1
(43) Pub. Date: Jul. 2, 2020

(54) MIMO ANTENNA SYSTEM AND ELECTRONIC DEVICE

(71) Applicant: AAC Technologies Pte. Ltd., Singapore City (SG)

(72) Inventor: Mao Liu, Shenzhen (CN)

(21) Appl. No.: 16/702,589

(22) Filed: Dec. 4, 2019

(30) Foreign Application Priority Data
Dec. 30, 2018 (CN) 201822278896.6

(51) Int. Cl. H01Q 21/00; H04B 7/0413

(52) U.S. Cl. CPC H01Q 21/0006; H04B 7/0413

(57) ABSTRACT

A MIMO antenna system is provided, including an antenna unit, and feed networks for feeding the antenna unit in a differential way, the feed networks comprise a first feed network that performs +45° polarization feeding on the antenna unit and a second feeding network that performs −45° polarization feeding on the antenna unit, the first feeding network and the second feeding network are orthogonal to each other, the first feed network and the second feed network comprise a first polarization feed port and a second polarization feed port respectively connected to an external circuit, and the feed networks perform ±45° polarization feeding on the antenna unit through the first and second polarization feed ports. Compared with related art, the present disclosure has small thickness, simple structure and low production cost, thereby providing a certain technical support for standardization and practical application of a large-scale MIMO in 5G systems.

### TECHNICAL FIELD

The present disclosure relates to the field of communication technologies, and more particularly, to a MIMO antenna system.

### BACKGROUND

As a key technology of 5G communication, a large-scale MIMO has received extensive attention from worldwide scholars. The large-scale MIMO makes full use of a spatial freedom by configuring tens or even hundreds of antennas at a base station, thereby improving a spectrum efficiency and a data transmission rate of a communication system. However, as environmental problems caused by global warming continue to intensify, voices for green communication are also growing. Although the large-scale MIMO can utilize a large number of antennas to increase a system capacity, a corresponding hardware cost and signal processing complexity also increase with the increase of the antennas. Therefore, it is important to find an effective way to reduce the cost while taking advantages of the large-scale MIMO system.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a MIMO antenna system of the present disclosure;

FIG. 2 is a structural schematic diagram of a feed network of a MIMO antenna system of the present disclosure;

FIG. 3 illustrates a frequency-S parameter graph of a MIMO antenna system of the present disclosure;

FIG. 4 illustrates a frequency-S parameter graph of a first polarization feed port and a second polarization feed port in a feed network of the present disclosure;

FIG. 5 illustrates a frequency-S parameter graph of a first feed point and a first polarization feed port, and a second feed point and a first polarization feed port in a first feed network of the present disclosure;

FIG. 6 illustrates a frequency-S parameter graph of a third feed point and a second polarization feed port, and a fourth feed point and a second polarization feed port in a second feed network of the present disclosure;

FIG. 7 illustrates a frequency-S parameter graph of a first polarization feed port and a second polarization feed port of a MIMO antenna system of the present disclosure;

FIG. 8 illustrates a frequency-S parameter graph of a second polarization feed port to a first polarization feed port, and the first polarization feed port to a second polarization feed port of a MIMO antenna system of the present disclosure;

FIG. 9 illustrates a first simulation graph of a MIMO antenna system of the present disclosure; and

FIG. 10 illustrates a second simulation graph of a MIMO antenna system of the present disclosure.

### DESCRIPTION OF EMBODIMENTS

The present disclosure will be further illustrated with reference to the accompanying drawings and the embodiments.

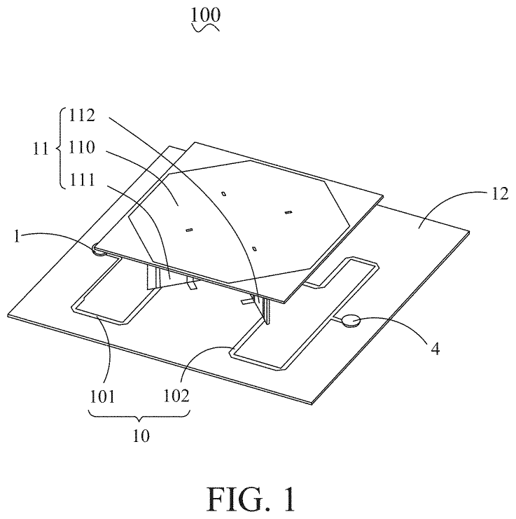

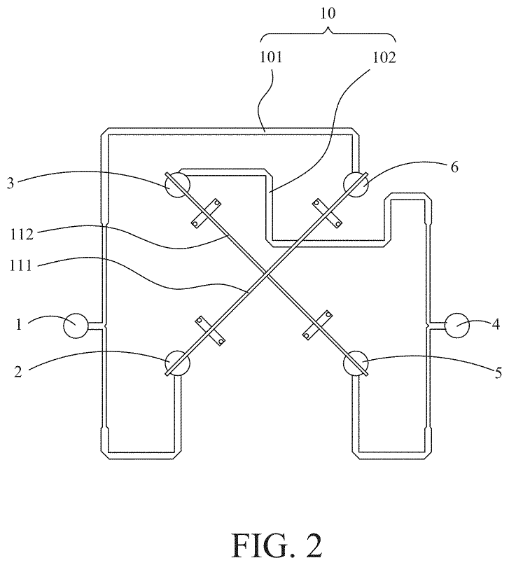

Referring to FIG. 1 and FIG. 2, an embodiment of the present disclosure provides a MIMO antenna system 100, and the MIMO antenna system 100 includes feed networks 10, an antenna unit 11, and a substrate plate 12. The feed networks 10 feed the antenna unit 11 in a differential way, and the feed networks 10 are implemented by a T-type power divider and a phase shifter.

The feed networks 10 include a first feed network 101 that performs +45° polarization feeding on the antenna unit 11 and a second feed network 102 that performs −45° polarization feeding on the antenna unit 11. The first feed network 101 and the second feed network 102 are arranged to be orthogonal to each other. The first feed network 101 includes a first polarization feed port 1, a first feed point 2, and a second feed point 3. The first feed point 2, the first polarization feed port 1, and the second feed point 3 are sequentially disposed. The second feed network 102 includes a second polarization feed port 4, a third feed point 5, and a fourth feed point 6. The third feed point 5, the second polarization feed port 4, and the fourth feed point 6 are sequentially disposed. The first feed point 2 and the second feed point 6 are disposed to crisscross with the third feed point 3 and the fourth feed point 5.

The first polarization feed port 1 and the second polarization feed port 4 are both connected to an external circuit. The feed networks 10 perform ±45° polarization feeding on the antenna unit 11 through the first polarization feed port 1 and the second polarization feed port 4.

The substrate plate 12 is shaped like a plate sheet, and the feed networks 10 and the antenna unit 11 are both fixed to the substrate plate 12.

The antenna unit 11 includes a flat-plate radiator 110 that is spaced apart from and in parallel with the substrate plate 12, a first support portion 111 and a second support portion 112. The first support portion 111 and the second support portion 112 support the radiator 110 on the substrate layer 12 and are disposed to crisscross with each other. The radiator 111 is electrically connected to the first feed point 2 and the second feed point 6 through the first support portion 111 and electrically connected to the third feed point 3 and the fourth feed point 5 through the second support portion 112.

In an embodiment of the present disclosure, a size of the radiator 110 is 48 mm *48 mm, and a height of the radiator 110 with respect to the substrate plate 12 is 15 mm.

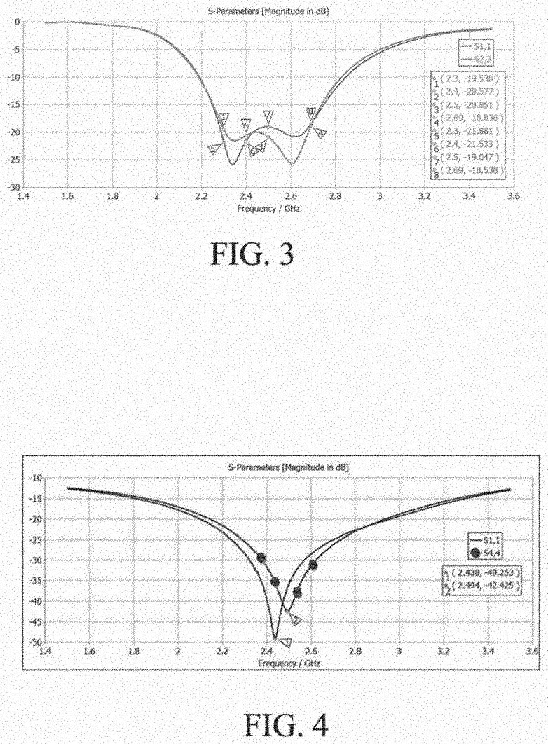

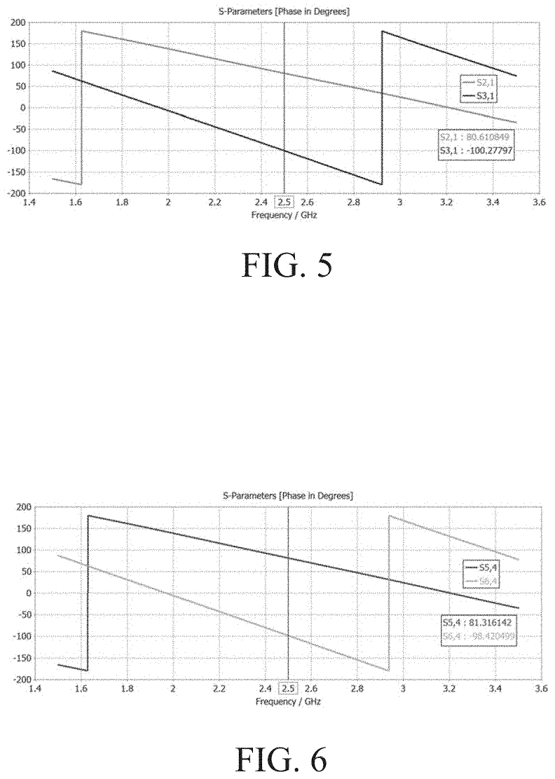

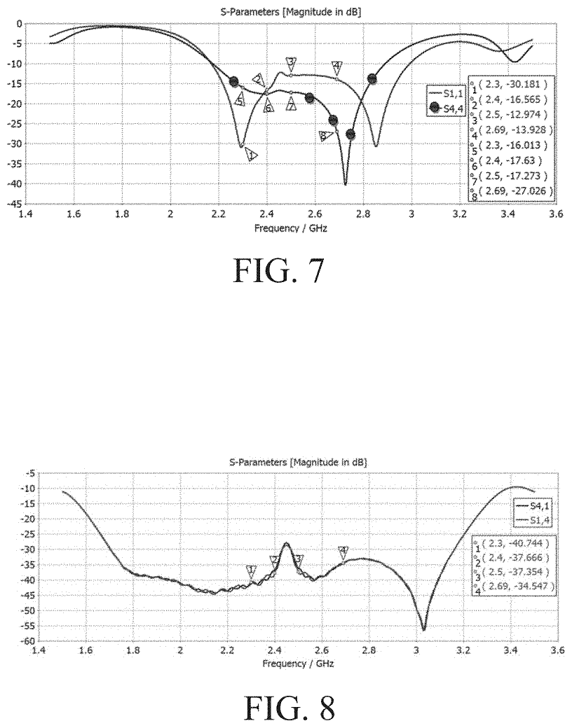

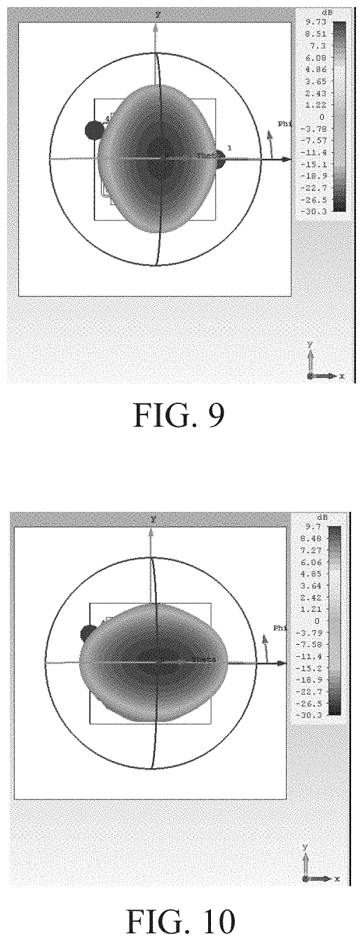

After experimental detection and simulation, frequency-S parameters of the MIMO antenna system of the present disclosure are as shown in FIG. 3; frequency-S parameters of the first polarization feed port and the second polarization feed port in the feed networks of the present disclosure are shown in FIG. 4; frequency-S parameters of the first feed point and the first polarization feed port, and the second feed point and the first polarization feed port in the first feed network of the present disclosure are shown in FIG. 5; frequency-S parameters of the third feed point and the second polarization feed port, and the fourth feed point and the second polarization feed port in the second feed network of the present disclosure are shown in FIG. 6; frequency-S parameters of the first polarization feed port and the second polarization feed port of the MIMO antenna system of the present disclosure are shown in FIG. 7; frequency-S parameters of the second polarization feed port to the first polarization feed port, and the first polarization feed port to the second polarization feed port of the MIMO antenna system of the present disclosure are shown in FIG. 8; and simulation graphs of the MIMO antenna system of the present disclosure are shown in FIG. 9 and FIG. 10.

Compared with the related art, the present disclosure has following beneficial effects: small thickness, simple structure and low production cost, thereby providing a certain technical support for standardization and practical application of a large-scale MIMO in 5G systems.

The above are merely embodiments of the present disclosure, and it should be noted herein that one ordinary person skilled in the art can make improvements without departing from the inventive concept of the present disclosure, but these are all within the protection scope of the present disclosure.

What is claimed is:

1. A MIMO antenna system, comprising:
an antenna unit, and
feed networks configured to perform differential feeding on the antenna unit, wherein the feed networks comprise a first feed network configured to perform +45° polarization feeding on the antenna unit and a second feeding network configured to perform −45° polarization feeding on the antenna unit, the first feeding network and the second feeding network are arranged to be orthogonal to each other, the first feed network comprises a first polarization feed port connected to an external circuit, the second feed network comprises a second polarization feed port connected to the external circuit, the first feed networks perform +45° polarization feeding on the antenna unit through the first polarization feed port and the second feed networks perform −45° polarization feeding on the antenna unit through the second polarization feed port.

2. The MIMO antenna system as described in claim 1, wherein one of the feed networks comprise a T-type power divider and a phase shifter.

3. The MIMO antenna system as described in claim 1, further comprising a substrate, on which the feed networks are arranged, wherein the antenna unit is fixed to the substrate.

4. The MIMO antenna system as described in claim 2, further comprising a substrate, on which the feed networks are arranged, wherein the antenna unit is fixed to the substrate.

5. The MIMO antenna system as described in claim 3, wherein the antenna unit comprises a flat-plate radiator spaced apart from and in parallel with the substrate, a first support portion, and a second support portion, wherein the first support portion and the second support portion support the flat-plate radiator on the substrate and are disposed to crisscross with each other.

6. The MIMO antenna system as described in claim 4, wherein the antenna unit comprises a flat-plate radiator spaced apart from and in parallel with the substrate, a first support portion, and a second support portion, wherein the first support portion and the second support portion support the flat-plate radiator on the substrate and are disposed to crisscross with each other.

7. The MIMO antenna system as described in claim 5, wherein the first feed network further comprises a first feed point and a second feed point, the first feed point and the second feed point are electrically connected to the first support portion, and the first feed point, the first polarization feed port, and the second feed point are sequentially disposed; the second feed network further comprises a third feed point and a fourth feed point, the third feed point and the fourth feed point are electrically connected to the second support portion, and the third feed point, the second polarization feed port, and the fourth feed point are sequentially disposed; and the first feed point and the second feed point are disposed to crisscross with the third feed point and the fourth feed point.

8. The MIMO antenna system as described in claim 6, wherein the first feed network further comprises a first feed point and a second feed point, the first feed point and the second feed point are electrically connected to the first support portion, and the first feed point, the first polarization feed port, and the second feed point are sequentially disposed; the second feed network further comprises a third feed point and a fourth feed point, the third feed point and the fourth feed point are electrically connected to the second support portion, and the third feed point, the second polarization feed port, and the fourth feed point are sequentially disposed; and the first feed point and the second feed point are disposed to crisscross with the third feed point and the fourth feed point.

9. The MIMO antenna system as described in claim 5, wherein a size of the flat-plate radiator is 48 mm*48 mm, and a height of the radiator relative to the substrate is 15 mm.

10. The MIMO antenna system as described in claim 6, wherein a size of the flat-plate radiator is 48 mm*48 mm, and a height of the radiator relative to the substrate is 15 mm.
